(19) United States
(12) Patent Application Publication
(10) Pub. No.: US 2021/0059238 A1
(43) Pub. Date: Mar. 4, 2021

(54) Fan With Support For Mosquito Coil

(71) Applicants: Denis Remi Proulx, Warren (CA); Aline Proulx, Warren (CA)

(72) Inventors: Denis Remi Proulx, Warren (CA); Aline Proulx, Warren (CA)

(21) Appl. No.: 17/004,286

(22) Filed: Aug. 27, 2020

Related U.S. Application Data
(60) Provisional application No. 62/892,717, filed on Aug. 28, 2019.

(51) Int. Cl. A01M 29/12; F04D 13/06; F04D 29/40

(52) U.S. Cl. CPC A01M 29/12; F04D 29/403; F04D 13/068

(57) ABSTRACT

A fan with support for a mosquito coil includes a housing having an open front end and an open rear end. A fan assembly is secured to the open front end of the housing. The fan assembly includes a fan blade, a battery powered fan motor, a blade guard, and a control panel. The open rear end of the housing includes a pair of channels that extend toward the open front end of the housing. The channels are sized to receive and support a mosquito coil within the housing. When the fan is activated via the control panel, air is drawn through the open rear end of the housing, around the mosquito coil, and expelled through the open front end of the housing. In this way, the fan spreads the airborne mosquito coil material to the surrounding area, increasing the effectiveness of the mosquito coil.

### CROSS REFERENCE TO RELATED APPLICATIONS

This application claims the benefit of Provisional Patent Application No. 62/892,717 filed on Aug. 28, 2019. The above identified patent application is herein incorporated by reference in its entirety to provide continuity of disclosure.

### BACKGROUND OF THE INVENTION

The present invention relates to mosquito and pest repelling devices. More specifically, the present invention provides a fan with support for a mosquito coil, whereby the fan spreads the mosquito coil material to the surrounding area to increase its effectiveness.

Individuals who enjoy outdoor recreational activities often have to contend with mosquitos and similar pests. Particularly in the summer months, mosquitos can be prevalent in many areas. In addition to being a general annoyance, mosquitos can spread disease and cause irritating allergic reactions when they bite an individual. One way to combat mosquitos is to use a device called a mosquito coil. Mosquito coils typically include a housing that supports a flammable material, such as a compound composed of dried pyrethrum powder and other ingredients, which emits a mosquito-repelling incense when burned. The compound is typically formed into a coil-shaped wick. When the end of the wick is ignited, the compound slowly burns toward the center of the suspended coil, continuously releasing the mosquito-repelling smoke. The user can typically open the housing, remove the spent coil, and replace it with a new coil.

The mosquito coil has many advantages. It is cheap to produce and sell, easy to replace when needed, and considered to be less of a health hazard than harmful pesticides and other hazardous chemical-based mosquito-repelling sprays. However, one disadvantage of the mosquito coil is the lack of a means for controlling the emission of the mosquito-repelling smoke. If there is a strong wind, the smoke is blown away before it can take effect in the immediate area. If there is no wind, the smoke is likely to travel straight upward and not dissipate to the surrounding area where mosquitos are present. In order to address the above concerns, the present invention provides a fan with support for a mosquito coil that uses forced air to spread the mosquito repelling smoke in a desired direction as the coil burns, thereby increasing the effectiveness of the mosquito coil.

Devices have been disclosed in the known art that relate to forced-air type mosquito repellants. However, these devices have several know drawbacks. These devices often spray hazardous chemicals that can harm individuals. Other devices exist that require propane or other dangerous materials. Such devices are often expensive and difficult to operate. Overall, the devices in the known art lack the ability to easily support a mosquito coil, such that the coil can be replaced as needed, with a fan that spreads the smoke from the mosquito coil to increase its effectiveness.

In light of the devices disclosed in the known art, it is submitted that the present invention substantially diverges in design elements from the known art and consequently it is clear that there is a need in the art for an improvement to existing mosquito repelling devices. In this regard the present invention substantially fulfills these needs

### SUMMARY OF THE INVENTION

In view of the foregoing disadvantages inherent in the known art, it is submitted that the present invention substantially diverges in design elements from the prior art and consequently it is clear that there is a need in the art for an improvement to existing mosquito repelling systems, particularly with regard to their ability to support a mosquito coil and control the direction of the smoke emitted by the mosquito coil. In this regard, the present invention substantially fulfills these needs.

In one embodiment, the present invention includes a housing having an open front end and an open rear end. A fan assembly is secured to the open front end of the housing. The fan assembly includes a fan blade operably connected to a battery powered fan motor, a blade guard, and a control panel operably connected to the fan motor. A pair of channels extend from the open rear end of the housing toward the front end of the housing. Each channel of the pair of channels is sized and configured to receive and support a mosquito coil within the housing. In operation, the user can secure the mosquito coil within the housing, such that the sides of the mosquito coil extend outwardly through the channels on either side of the housing. When the user activates the fan via the control panel, air is drawn through the open rear end of the housing, around the mosquito coil, and expelled through the open front end of the housing. In this way, the fan spreads the airborne mosquito coil material to the surrounding area.

It is therefore an object of the present invention to provide a new and improved fan with mosquito coil support that has all of the advantages of the prior art and none of the disadvantages.

It is another object of the present invention to provide a fan with mosquito coil support that includes a reflective interior layer for preventing the device from overheating due to the heat of the burning mosquito coil.

A further object of the present invention is to provide a fan with mosquito coil support that is easily transportable and is easy to resupply with new mosquito coils when an old one is burned out.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of an embodiment of the fan with support for a mosquito coil.

FIG. 2 shows a side elevation view of an embodiment of the fan with support for a mosquito coil.

FIG. 3 shows a rear perspective view of an embodiment of the fan with support for a mosquito coil.

FIG. 4 shows a side elevation view of an embodiment of the fan with support for a mosquito coil, showing the mosquito coil removed.

### DETAILED DESCRIPTION OF THE INVENTION

Reference is made herein to the attached drawings. Like reference numerals are used throughout the drawings to depict like or similar elements of the moisture sensor. For the purposes of presenting a brief and clear description of the present invention, the invention will be discussed as being used for increasing the effectiveness of a mosquito coil. The figures are intended for representative purposes only and should not be considered to be limiting in any respect.

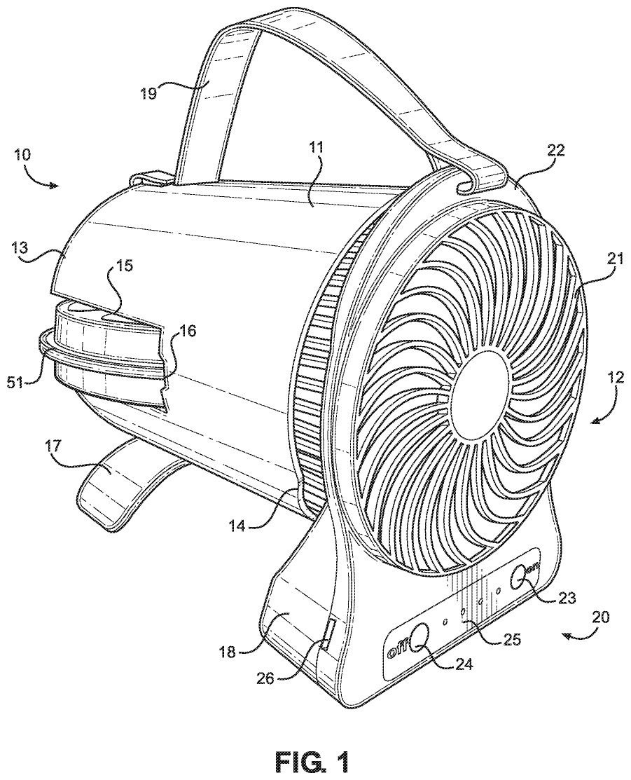

Referring now to FIGS. 1-4, there are shown a multiple views of an embodiment of the fan with support for a mosquito coil. The fan with support for a mosquito coil, or the device 10, generally includes a housing 11 having an open front end 14 and an open rear end 13 defining an open interior volume. In the illustrated embodiment, the housing 11 is cylindrical, but other shapes may be utilized. A fan assembly 12 is secured to the open front end 14 of the housing 11. In the illustrated embodiment, the fan assembly 12 is inserted into the open front end 14, such that the interior of the housing 11 frictionally engages the exterior of the fan assembly 12. In other embodiments, other fasteners or connections between the fan assembly 12 and housing 11 may be utilized. In yet another embodiment, the fan assembly 12 can be integrally formed with the housing 11.

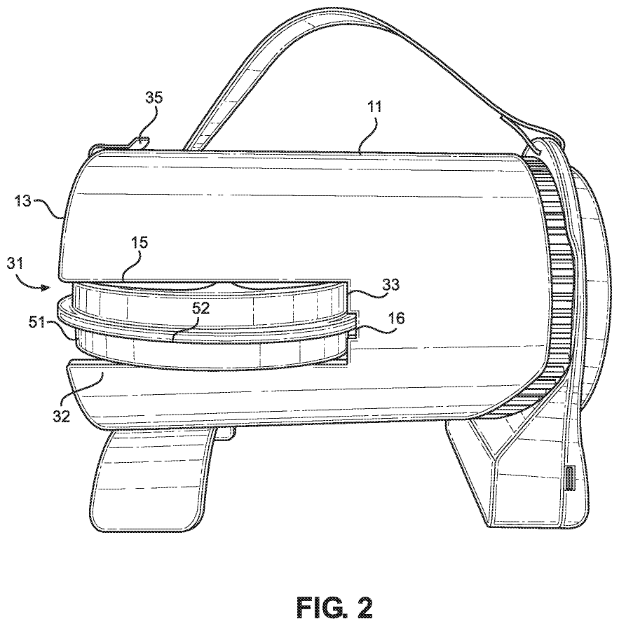

The device 10 may include a handle to make the device 10 easily transportable to a desired location for use. In the shown embodiment, the device 10 includes a handle 19 comprising a flexible strap having a first end affixed to the fan assembly 22 and a second end connected to the housing 11, most clearly visible in FIGS. 1 and 2. This arrangement helps to maintain the connection between the fan assembly 12 and the housing 11. In some embodiments, the handle 19 can be adjustable in length to make the device 10 more comfortable to carry. In other embodiments, the handle 19 can include other configurations, such as a rigid carrying handle or an elongated strap for supporting the device 10 over the shoulder, for example.

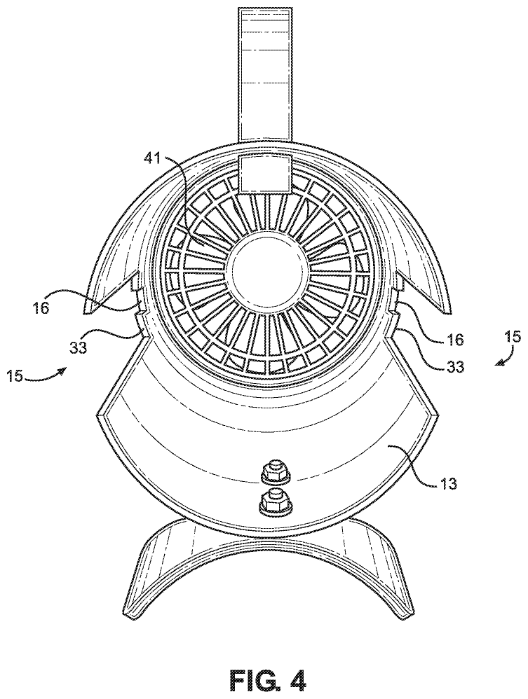

The fan assembly 12 includes a fan blade 41 (visible in FIG. 4) operably connected to a battery powered fan motor (not visible). The fan assembly 12 should be understood to utilize existing battery-powered fan technology which includes a battery-powered motor that rotates a shaft having radially attached fan blades. The fan assembly 12 also includes a blade guard 21 for safety purposes. The blade guard 21 prevents an individual from accidentally contacting the fan blades 41 while the fan is operational. The fan assembly 12 further includes a control panel 20 operably connected to the fan motor, which allows the user to control the operation of the fan assembly 12. In the illustrated embodiment, visible in FIG. 1, the control panel includes an on button 23 configured to activate the fan motor when pressed and an off button 24 configured to deactivate the fan motor when pressed. The fan assembly 12 also includes a USB port 26 which is operably connected to the battery that powers the fan motor, such that a power source can be connected to the USB port 26 to recharge the battery. Additional lights and buttons 25 may be disclosed on the control panel 20. The fan assembly 12 can include any number of control options, including but not limited to a fan speed control to select a desired fan speed and a fan timer control to select an amount of time for which the fan will remain active when turned on.

A pair of channels 15 extend from the open rear end 13 of the housing 11 toward the open front end 14 of the housing 11. Each channel 15 is sized and configured to receive and support a mosquito coil 51 within the housing 11. As shown in FIG. 4, the channels 15 are positioned on opposing sides of the housing 11 and are symmetrical in construction such that they evenly support the mosquito coil 51. In the shown embodiment, each channel includes a notch 16 in its forward edge 33. The notch 16 accommodates the perimeter lip 52 that extends annularly around a typical mosquito coil 51, ensuring a secure fit and connection between the housing 11 and the mosquito coil 51.

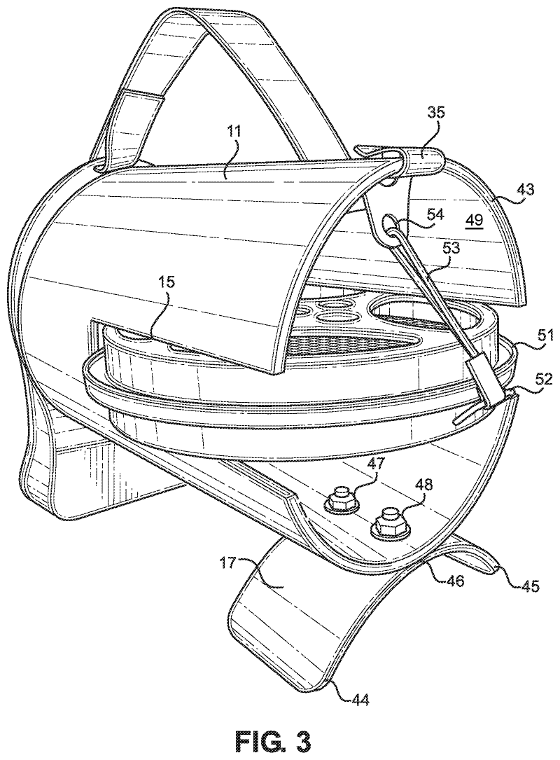

In the shown embodiment, most clearly visible in FIGS. 1 and 3, the device 10 includes a front support 18 connected to the fan assembly 20 and a rear support 17 affixed to the rear end of the housing 11. In the illustrated embodiment, the front support 18 is integral with the fan assembly 20. However, the fan assembly 20 can take on any number of shapes or configurations and may include integral, fixed, or removably attached supporting members. In the shown embodiment, most clearly visible in FIG. 3, the rear support 17 is an arcuate member having a pair of opposing support legs 44,45 curving downwardly from an upper end 46 that is secured to the housing 11. This configuration provides a stable support with multiple contact points to prevent the device 10 from accidentally tipping over while it is in use. In the shown embodiment, the rear support 17 is secured to the housing 11 via a pair of threaded bolt-type fasteners 47, 48. However, in other embodiments, the device 10 can utilized different types and numbers of fasteners to secure the rear support 17 to the housing, or the rear support 17 may be integrally formed with the housing 11.

Referring now to FIG. 3, there is shown a rear perspective view of an embodiment of the fan with support for a mosquito coil. In the illustrated embodiment, the mosquito coil 51 includes an attached tether 53. The distal end of the tether is threaded through an aperture 54 disposed on a clip 35. The clip 35 includes a pair of inwardly biased jaws that engage the perimeter edge 43 of the rear end of the housing 11. In this way, the mosquito coil 51 can be further secured to the housing 11. Additionally, in the illustrated embodiment, the interior surface 49 of the housing 11 includes a reflective material, such as an attached layer of aluminum foil or a layer of reflective paint or similar coatings, for example. The reflective material helps reflect heat emitted from the burning mosquito coil 51 away from the housing 11, preventing the heat from damaging the housing 11 if the mosquito coil 51 is burned for a long period of time. The interior surface 49 can be either partially coated or entirely coated with the reflective material. In one embodiment, only the upper half of the housing 11 includes the reflective coating in order to reflect the upwardly traveling heat from the mosquito coil 51.

In operation, the user can transport the device 10 to a desired location. The user can then secure a mosquito coil 51 within the channels 15 of the housing 11. The open rear end 13 of the housing 11 allows users to easily access the mosquito coil 51 to ignite it with a match, lighter, or the like. Alternatively, the user can ignite the mosquito coil 51 prior to securing it within the housing 11. The user can then position the housing 11 such that the fan assembly 20 is oriented in a desired direction. When the user activates the fan assembly 20, air is drawn in through the open rear end 13 of the housing 11, overtop the lit mosquito coil 51, and out through the fan assembly 20. In this way, the smoke and vaporized material from the burning mosquito coil 51 is directed towards and forced to a desired area. Also, since a portion of the mosquito coil 51 extends outwardly beyond the outer walls of the housing 11, some of the material emitted by the mosquito coil 51 will remain in the area surrounding the device 10. In this way, the user can maximize the effectiveness of the mosquito coil 51 and concentrate its emitted mosquito-repelling materials in a desired area.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fan and mosquito coil support device, comprising:
a housing having an open front end and an open rear end;
a fan assembly secured to the open front end of the housing, the fan assembly comprising a fan blade operably connected to a battery powered fan motor, a blade guard, and a control panel operably connected to the fan motor;
a pair of channels extending from the open rear end of the housing toward the front end of the housing;
wherein each channel of the pair of channels is configured to receive and support a mosquito coil within the housing.

2) The fan and mosquito coil support device of claim 1, further comprising a front support integral with the fan assembly and a rear support affixed to a rear end of the housing.

3) The fan and mosquito coil support device of claim 2, wherein the rear support comprises an arcuate member having a pair of opposing support legs curving downwardly from an upper end that is secured to the housing via one or more fasteners.

4) The fan and mosquito coil support device of claim 1, further comprising a handle.

5) The fan and mosquito coil support device of claim 4, wherein the handle comprises a flexible strap that having a first end affixed to the housing and a second end affixed to an upper lip of the fan assembly.

6) The fan and mosquito coil support device of claim 1, wherein the fan assembly control panel includes an on button configured to activate the fan motor when pressed and an off button configured to deactivate the fan motor when pressed.

7) The fan and mosquito coil support device of claim 6, further comprising one or more additional buttons disposed on the control panel, the one or more additional buttons configured to selectively control an operational speed of the fan motor when pressed.

8) The fan and mosquito coil support device of claim 1, further comprising a layer of reflective material disposed on an interior surface of the housing.

9) The fan and mosquito coil support device of claim 1, wherein each channel of the pair of channels includes a forward edge having a notch extending toward the front end of the housing, wherein each notch is configured to receive a perimeter lip of a mosquito coil.

10) The fan and mosquito coil support device of claim 1, the fan assembly further comprising a USB port operably connected to the rechargeable battery.

11) A fan and mosquito coil support device, comprising:
a housing having an open front end and an open rear end;
a fan assembly secured to the open front end of the housing, the fan assembly comprising a fan blade operably connected to a battery powered fan motor, a blade guard, and a control panel operably connected to the fan motor;
a pair of channels extending from the open rear end of the housing toward the front end of the housing;
a mosquito coil comprising a connector, a tether having a first end connected to the connector, and a clip attached to an opposing second end of the tether, wherein the clip is configured to removably secure to a rear edge of the housing;
wherein each channel of the pair of channels is configured to receive and support the mosquito coil.

12) The fan and mosquito coil support device of claim 11, further comprising a front support integral with the fan assembly and a rear support affixed to a rear end of the housing.

13) The fan and mosquito coil support device of claim 12, wherein the rear support comprises an arcuate member having a pair of opposing support legs curving downwardly from an upper end that is secured to the housing via one or more fasteners.

14) The fan and mosquito coil support device of claim 11, further comprising a handle.

15) The fan and mosquito coil support device of claim 14, wherein the handle comprises a flexible strap that having a first end affixed to the housing and a second end affixed to an upper lip of the fan assembly.

16) The fan and mosquito coil support device of claim 11, wherein the fan assembly control panel includes an on button configured to activate the fan motor when pressed and an off button configured to deactivate the fan motor when pressed.

17) The fan and mosquito coil support device of claim 16, further comprising one or more additional buttons disposed on the control panel, the one or more additional buttons configured to selectively control an operational speed of the fan motor when pressed.

18) The fan and mosquito coil support device of claim 11, further comprising a layer of reflective material disposed on an interior surface of the housing.

19) The fan and mosquito coil support device of claim 11, wherein each channel of the pair of channels includes a forward edge having a notch extending toward the front end of the housing, wherein each notch is configured to receive a perimeter lip of the mosquito coil.

20) The fan and mosquito coil support device of claim 11, the fan assembly further comprising a USB port operably connected to the rechargeable battery.
